(19) United States
(12) Patent Application Publication
(10) Pub. No.: US 2022/0358333 A1
(43) Pub. Date: Nov. 10, 2022

(54) AUTOMATIC ANNOTATION USING GROUND TRUTH DATA FOR MACHINE LEARNING MODELS

(71) Applicant: Ford Global Technologies, LLC, Dearborn, MI (US)

(72) Inventors: Geoffrey Horowitz, Farmington Hills, MI (US); Meghna Menon, Rochester Hills, MI (US); Ling Zhu, Canton, MI (US); Gregory P. Linkowski, Dearborn, MI (US)

(73) Assignee: Ford Global Technologies, LLC, Dearborn, MI (US)

(21) Appl. No.: 17/314,875

(22) Filed: May 7, 2021

(51) Int. Cl. G06K 9/62; G06K 9/20; G06T 7/155; G06K 9/00

(52) U.S. Cl. CPC G06K 9/6257; G06K 9/2054; G06T 7/155; G06K 9/00201; G06K 9/6262

(57) ABSTRACT

This disclosure describes systems, methods, and devices related to automatic annotation. A device may capture data associated with an image comprising an object. The device may acquire input data associated with the object. The device may estimate a plurality of points within a frame of the image, wherein the plurality of point constitute a 3D bounding to around the object. The device may transform the plurality of points to two or more 2D points. The device may construct a bounding box that encapsulates the object using the two or more 2D points. The device may create a segmentation mask of the object using morphological techniques. The device may perform annotation based on the segmentation mask.

### BACKGROUND

Machine learning is increasingly being used to solve complex problems, for example, in robotics or other fields, including problems of robotic identification and classification within frames of images. Current machine learning classification training requires a large set of annotated input sample data for training and validation of the machine learning model. These input sample data need to be labeled or annotated, especially with images.

### BRIEF DESCRIPTION OF THE DRAWINGS

FIG. 1 depicts an illustrative schematic diagram for automatic annotation, in accordance with one or more example embodiments of the present disclosure.

FIG. 2 depicts an illustrative schematic diagram for automatic annotation, in accordance with one or more example embodiments of the present disclosure.

FIG. 3 depicts an illustrative schematic diagram for automatic annotation, in accordance with one or more example embodiments of the present disclosure.

FIG. 4 depicts an illustrative schematic diagram for automatic annotation, in accordance with one or more example embodiments of the present disclosure.

FIG. 5 depicts an illustrative schematic diagram for automatic annotation, in accordance with one or more example embodiments of the present disclosure.

FIG. 6 depicts an illustrative schematic diagram for automatic annotation, in accordance with one or more example embodiments of the present disclosure.

FIG. 7 illustrates a flow diagram of an illustrative process for an illustrative automatic annotation system, in accordance with one or more example embodiments of the present disclosure.

FIG. 8 is a block diagram illustrating an example of a computing device or computer system upon which any of one or more techniques (e.g., methods) may be performed, in accordance with one or more example embodiments of the present disclosure.

### DETAILED DESCRIPTION

The following description and the drawings sufficiently illustrate specific embodiments to enable those skilled in the art to practice them. Other embodiments may incorporate structural, logical, electrical, process, algorithm, and other changes. Portions and features of some embodiments may be included in, or substituted for, those of other embodiments. Embodiments set forth in the claims encompass all available equivalents of those claims.

### Overview

Historically, each annotated sample required a user to manually draw a bounding box around an object (e.g., a robot or other objects) to be trained on and classify it accordingly. For example, a person draws a contour around an apple in a picture, and classify it as “apple” for the machine learning model to be able to identify the apple in the picture at a later time. In other words, although images are captured by a camera, these images are not automatically annotated in order to determine what objects are in these images. For example, if a camera captures an image of a robot, the user knows that it is a robot but the camera or the system does not without some form of annotation. This manual annotation process takes a large amount of resources (time and money), either in the form of an employee's time or utilizing a service to provide the annotations.

There is a need to accomplish a faster and more efficient annotation of a large dataset associated with images. For example, if a camera captures 10,000 image frames, and an object (e.g., a robot) is found in 5,000 of these frames, at different locations, orientation, and scales, in order to train a neural network, it is required that for each image to know whether the robot is in the image. Further, it may be required that the contour of the object is known in the image in the form of image coordinates.

Example embodiments of the present disclosure relate to systems, methods, and devices for an automatic annotation process utilizing synchronized ground truth data for use in customized machine learning models.

In one or more embodiments, an automatic annotation system may facilitate the use of synchronized ground truth data to identify and convert the position of an object (e.g., a robot, an apple, a statue, or any other object) quickly and efficiently. Specifically, the use of data that is obtained by sensor localization during collection of dataset images, and synchronizing that data collection, is an important aspect of process described in this disclosure. The process involved in using this synchronized data to create the inputs to machine learning models is then distinctive for this method of data collection.

The input data may be time-synchronized poses for the object, however, it is important to note how the input data is produced. The input data may be associated with a prebuilt map and normal distribution transform (NDT) matching to localize the object. Other methods may also be used in order to localize the object. Overall, the process as whole encompasses a novel idea because the steps described, done in this particular order and using the decision criteria described, enable an automatic annotation process that currently does not exist. For example, the dimensions of an object (e.g., a robot, an apple, a statue, or any other object) may be known, which allows the creation of a 3D bounding cube in the world frame around that object. Prior solutions in the space of auto-annotation appears to be in text-based annotation which is a different use case and different process than the one needed for annotation of objects in captured images. Similarly, image-related solutions with respect to generating training sets also rely on implementing generative adversarial networks, or crowdsourcing annotations and using ground truth to validate as opposed to creating annotations directly from the dataset as described in this disclosure.

In one or more embodiments, once a 3D bounding cube is determined, an automatic annotation system may facilitate projecting the 3D bounding cube into a 2D image plane. This projection is achieved by using a downsampling of a number of points (e.g., 8 points) in the 3D bounding cube into a smaller number of points in the 2D image plane (e.g., 4 points). This downsampling is performed by selecting specific points that would result in encompassing the object (e.g., the robot) within an image frame. This process may then be applied to a large number of images.

In one or more embodiments, an automatic annotation system has a number of advantages, such as, saving resources and time. For example, if a dataset comprises 10,000 images and if it takes a person 30 secs to manually annotate each image, that equates to approximately 83.3 hours or over two weeks of work. Alternatively, if the annotation process is outsourced at an approximate cost of $1 per annotation, that would cost $10,000. The process outlined here can be completed in minutes and include negligible costs.

The above descriptions are for purposes of illustration and are not meant to be limiting. Numerous other examples, configurations, processes, algorithms, etc., may exist, some of which are described in greater detail below. Example embodiments will now be described with reference to the accompanying figures.

### Illustrative Embodiments

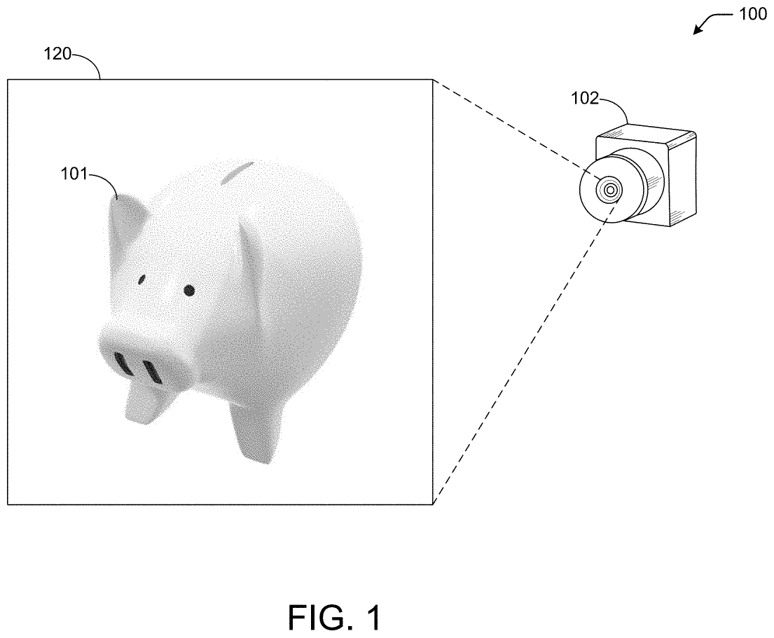

FIG. 1 depicts an illustrative schematic diagram 100 for automatic annotation, in accordance with one or more example embodiments of the present disclosure.

Referring to FIG. 1, there is shown an image 120 of an original object 101 (e.g., a statue of a pig). This original object 101 may be found in one or more images that may have been captured using a camera 102. The camera 102 may have captured a large number of images and various orientation of the object 101. The object 101 may be a 3D object having known dimensions and/or coordinates within the image. An operator may be interested in annotating this object in order to provide training sets for a machine learning process.

In one or more embodiments, an automatic annotation system may facilitate capturing input data associated with the object 101. For example, the input data may include the dimension object 101. This information may be obtained from specification sheets of the object 101 or from obtaining manual measurements. Ground truth data of the object 101 may be obtained relative to a known frame during the same time as image collection. Some examples of mechanisms using sensor or other mechanisms that may be used to create the ground truth, including but not limited to, light detection and ranging (LIDAR), inertial measurement unit (IMU), odometry, or other mechanisms. These mechanisms would be able to obtain a six degree-of-freedom (DOF) pose of the object 101.

One or more synchronization methods may be used to align the object 101's pose data within the image capture data. Further, the camera 102 may need to be calibrated relative to a known world frame with transformations known between the known world frame and the frame used for ground truth collection. Any camera calibration techniques may be used.

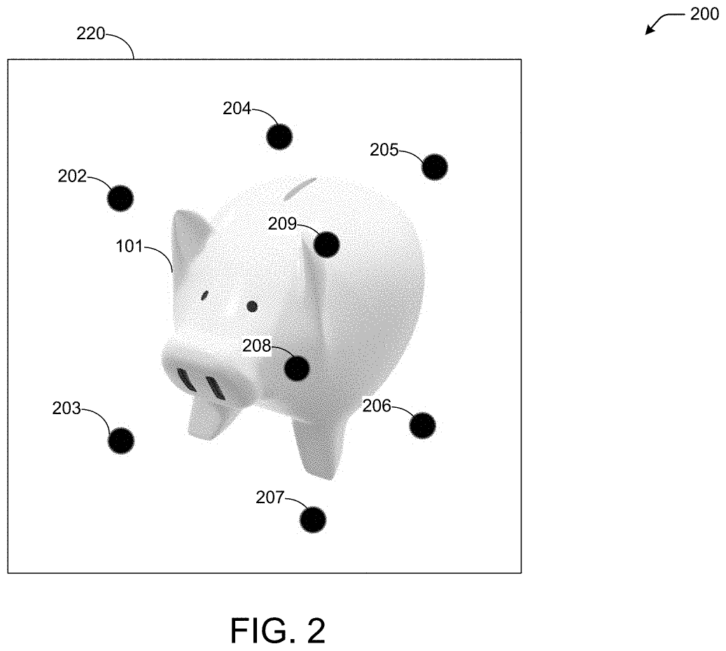

FIG. 2 depicts an illustrative schematic diagram 200 for automatic annotation, in accordance with one or more example embodiments of the present disclosure.

Referring to FIG. 2, there is shown a set of 3D bounding cube points (e.g., points to a 202-209) within an image frame 220 based on an object (e.g., object 101) dimensions that are known to the system (e.g., obtained from specification sheets or manual measurements). The set 3D bounding cube points 202-209 may have the characteristic of bounding the object 101 in 3D space. The set 3D bounding cube points 202-209 form a cube filling the entire object 101 as closely as possible. From ground truth data in the world frame, the automatic annotation system may estimate these 3D bounding cube points. That is ground truth data and known dimensions of the object 101 may be used to compose a 3D bounding box.

In one or more embodiments, the automatic annotation system may transform these points to image coordinates in the camera frame. For example, in FIG. 2, there are shown eight points 202-209 that construct the bounding box that fully encapsulates the object 101. Using morphological techniques, an automatic annotation system may create a segmentation mask of the object. Some of the morphological techniques include, but not limited to, a series of dilations, erosions, and gradient thresholding to remove small outlying clusters, fill in potential missing gaps, and ultimately can identify the contour of the foreground object, which defines both the edges and complete segmentation mask of the object.

In one or more embodiments, an automatic annotation system may identify the points needed to create a 3D bounding cube around the object 101, from the ground truth data, by adding and/or subtracting half of the object 101's height, width, and/or depth to the center point location of the object 101 to get each of the eight bounding points (e.g., points 202-209) in the (3D) world frame.

It should be noted that appropriate adjustment may need to be made to these calculations for yaw values (and roll/pitch if needed). These calculations may be completed using a homogenous transformation matrix from the world frame to the robot local frame using the ground truth data. In some examples, it may be assumed that the ground truth pose measures the location of the 3D middle (e.g., center) of the object 101 in the world space. This assumption is not necessary, adjustments for calculating 3D bounding cube would simply need to be made for other ground truth positions on the robot.

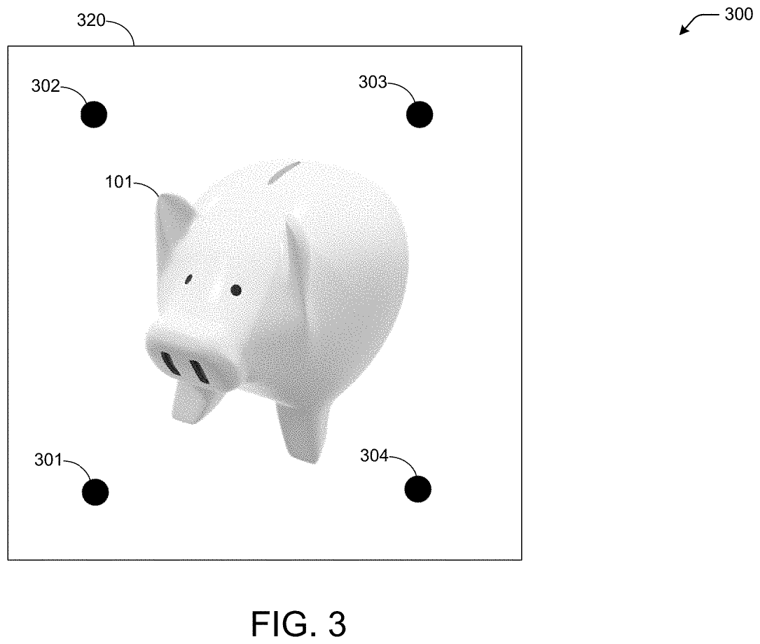

FIG. 3 depicts an illustrative schematic diagram 300 for automatic annotation, in accordance with one or more example embodiments of the present disclosure.

Referring to FIG. 3, there is shown the object 101 within an image frame 320, where four points are formed around it based on a transformation (e.g., downsampling) of the eight points (e.g., points 202-209) in FIG. 2 in order to surround the object 101. For example, using a homogenous transformation matrix obtained from camera calibration, an automatic annotation system may convert the eight 3D bounding cube points in the (3D) world frame to their corresponding (row, column) points in the (2D) image plane. This may result in 2D points 301, 302, 303, and 304.

It is understood that the above descriptions are for purposes of illustration and are not meant to be limiting.

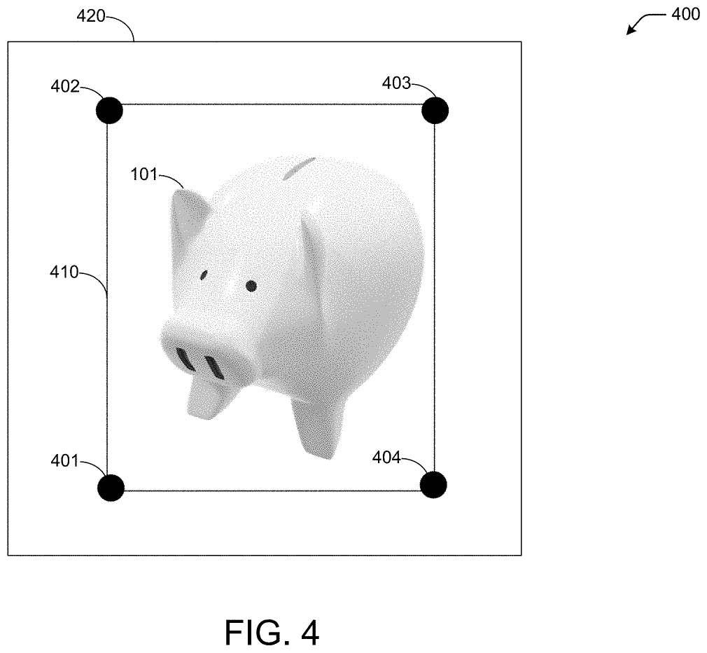

FIG. 4 depicts an illustrative schematic diagram 400 for automatic annotation, in accordance with one or more example embodiments of the present disclosure.

Referring to FIG. 4, there is shown the object 101, bound by a 2D box inside an image frame 420.

In one or more embodiments, an automatic annotation system may create a 2D bounding box 410 using the most extreme values of the eight points (e.g., points 202-209) in FIG. 2 and down selecting from eight to four image points. In order to so, the bounding box 410 may be defined by the four points 401, 402, 403, and 404 in (row, column) format. For example:

1) (minimum row, minimum column) of all 8 points.

2) (minimum row, maximum column) of all 8 points.

3) (maximum row, minimum column) of all 8 points.

4) (maximum row, maximum column) of all 8 points.

In one or more embodiments, an automatic annotation system may analyze the bounding box 410 to ensure that the bounding box 410 is fully contained within the image bounds. To do this, each of the points (e.g., point 401-404) can be considered relative to the dimensions of the image itself. If any of the points are outside of the image edges, they can be truncated to the image edge. While not necessary, additional post-processing can be added to this step. For example, looking at the resulting bounding box, knowing the size of object 101 (e.g., from input data), and the camera calibration, one can take a ratio of the bounding box size to the image size and normalize this by the size of the entire robot in pixels. If this normalized ratio is below a threshold, it can be determined that only a small portion of the object 101 is in the image and based on the hyper-parameters selected can be rejected as a poor training image.

It is understood that the above descriptions are for purposes of illustration and are not meant to be limiting.

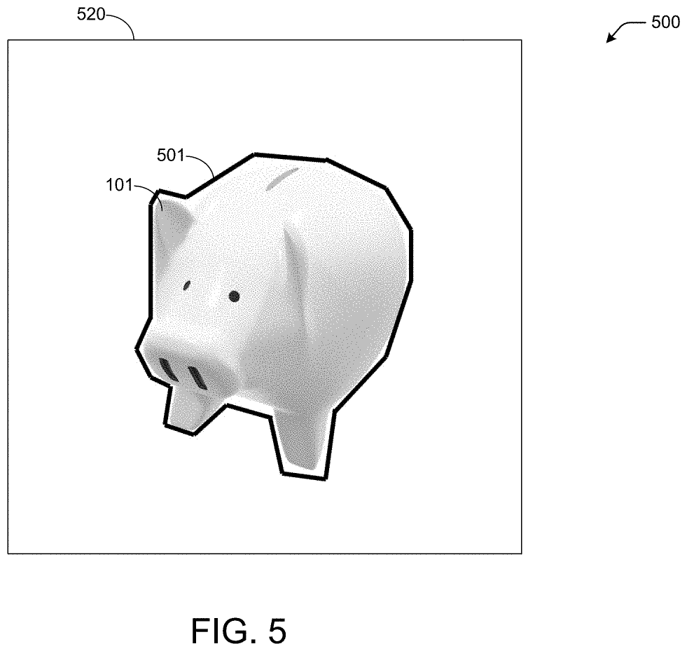

FIG. 5 depicts an illustrative schematic diagram 500 for automatic annotation, in accordance with one or more example embodiments of the present disclosure.

Referring to FIG. 5, there is shown the object 101 encapsulated by a fitted contour 501 within an image frame 520.

In one or more embodiments, an automatic annotation system may perform image segmentation for each image taken of the object 101 in order to determine the fitted contour 501 of the object 101. The fitted contour 501 may outline the shape of the object 101 edges.

In one or more embodiments, an automatic annotation system may separate items in the background from items not in the background (“foreground”). Based on prior steps, a determination of where the foreground object is achieved from the 2D bounding box. Then graph technique may be applied to identify connected pixels to the background portion, and morphological techniques to clean up the remainder. In one or more embodiments, an automatic annotation system may identify the foreground image frame via the bounding box identified in FIG. 4. The automatic annotation system may utilize a background subtraction algorithm to remove the background of the image. Background subtraction algorithms allow an image's foreground to be extracted for further processing. One example of a background subtraction algorithm, includes but are not limited to, the use of Opencv's open-source “GrabCut” method, which uses graph methods to find connected notes inside the foreground image that belongs to the background image (e.g., anything outside of the foreground box). With GrabCut, a rectangle is created around the foreground region such that the foreground region is completely inside the rectangle (e.g., as shown in FIG. 4), where the algorithm perform segmentations on the pixels with the rectangle. Although GrabCut is used in this example, any other mechanisms for background subtractions may be used, such as, clustering, temporal difference analysis, and/or min-cut/max-flow analyses. Techniques may use expectation maximization clustering algorithm to find the sets of connected components, then apply a min-cut algorithm to find the segmentation that provides the largest pixel difference between the background clusters and the foreground clusters. Other techniques like background subtraction, may determine how pixels change intensity values over time, with the underlying assumption that any change in the pixel values are attributable to the foreground objects, and so based on applying a threshold (to account for lighting noise), the grouping that results from only observing the moving pixels over time compose the object being analyzed for annotation.

In one or more embodiments, an automatic annotation system may apply a thresholding mask to differentiate the remaining foreground from the rest of the image. Image thresholding is a form of image segmentation. It is a way to create a binary image from a single band or multi-band image. The process is typically done in order to separate object or foreground pixels from background pixels to aid in image processing.

In one or more embodiments, an automatic annotation system may dilate existing pixel edges to fill in any gaps in the resulting binary image, then erode pixels to retrieve original foreground size. This is also a technique that relies on iterating through positive pixels and growing their edges if a gradient edge exists.

In one or more embodiments, an automatic annotation system may run an edge detection algorithm (e.g., algorithms may include Sobel and Canny edge detectors) and return the resulting edges as the contour points of the object 101 in pixels coordinates.

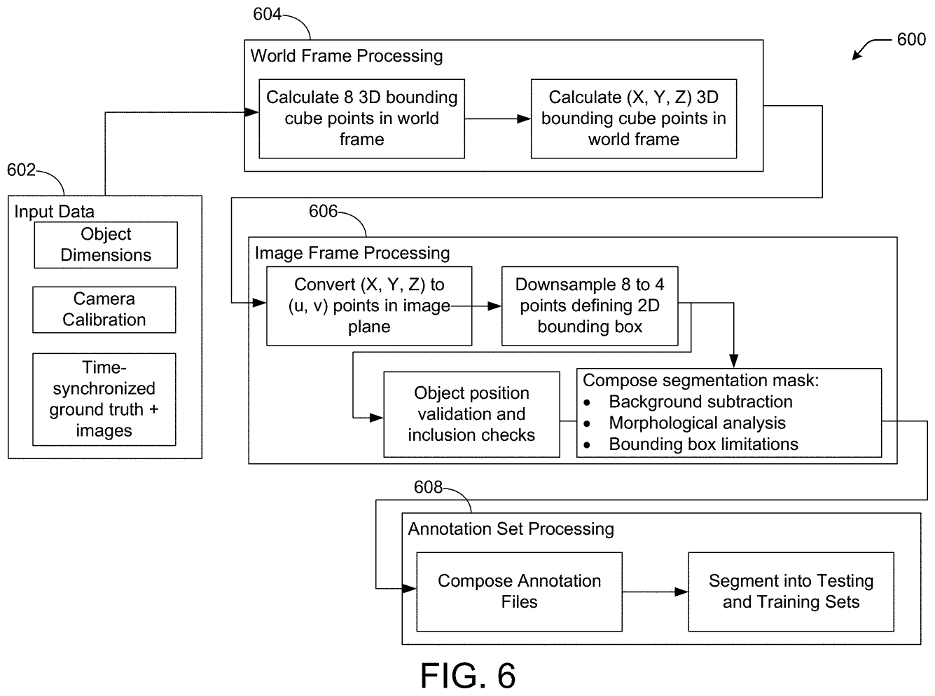

FIG. 6 depicts an illustrative schematic flow diagram 600 for automatic annotation, in accordance with one or more example embodiments of the present disclosure.

Referring to FIG. 6, there is shown one or more logical blocks of the flow diagram that comprise one or more processing steps.

In one or more embodiments, an automatic annotation system may process input data 602 associated with an object found in an image of a camera. The input data may comprise dimensions of the object, which may be obtained from various sources. For example, the dimensions of the object may be obtained from specification sheets or even from manual measurements of object. Further, ground truth of the object must be obtained relative to a known frame during the same time as image capture. Any sensor or assumptions capable of creating this ground truth could be used. For example, LIDAR, inertial measurement unit (IMU), odometry, or other devices. The object pose data may be aligned using a data synchronization method for example, time stamping, synchronization servers, etc. The camera may be calibrated using camera calibration. The camera calibration may be obtained relative to a known world frame, with transformations known between a frame associated with the image and the frame used for ground truth collection. In order to achieve calibration of the camera any camera calibration technique may be used.

In one or more embodiments, the automatic annotation system may perform world frame processing 604 to generate a bounding box identification. The automatic annotation system may obtain ground truth data by localizing the object in the world using a predetermined world map during collection of images from one or more cameras.

It should be noted that in cases where an object, such as a robot, does not have the sensing necessary to obtain this information, a single removable LIDAR can be used with a pre-recorded area map and placed on each object in turn. This provides for flexibility in object (e.g., robot types) while maintaining accuracy in the data collection process. Some additional information needed may be the transformation from the new sensor frame to the center of the object. Then, using the synchronized ground truth data associated with each image, an algorithm associated with the automatic annotation system may automatically do perform one or more process on each image.

In one or more embodiments, an automatic annotation system may identify the points needed to create a 3D bounding cube around the robot from the ground truth data by adding or subtracting a half of the robot's height, width, and/or depth to the center point location of the robot to get each of the eight bounding cube points in the 3D world frame.

Appropriate adjustment may need to be made to these calculations for yaw values (and roll/pitch if needed). These calculations can easily be done using a homogenous transformation matrix from the world frame to the robot local frame using the ground truth data.

For description purposes, it is assumed that the ground truth pose measures the location of the 3D middle (i.e. center) of the robot in world space. This assumption is not necessary, adjustments for calculating 3D bounding cube would simply need to be made for other ground truth positions on the robot.

In one or more embodiments, an automatic annotation system may perform image frame processing 606. Using the homogenous transformation matrix obtained from camera calibration, the automatic annotation system may convert all eight 3D bounding cube points in the 3D world frame to their corresponding (row, column) points in the 2D image plane. Taking a conservative approach (to ensure as much of the robot is including in the bounding box as possible), create a 2D bounding box using the most extreme values of the 8 points obtained (e.g., downselect/downsample from 8 to 4 image points). To do this, the bounding box will be defined by the following 4 points in (row, column) format: (minimum row, minimum column) of all 8 points, (minimum row, maximum column) of all 8 points, (maximum row, minimum column) of all 8 points, (maximum row, maximum column) of all 8 points.

In one or more embodiments, an automatic annotation system perform may analyze these results to ensure that at least some portion of the bounding box is within the image bounds. If any point is within the image bounds, the automatic annotation may continue the analysis. Otherwise, the robot is not in the image; therefore, the image should be skipped as no annotation is necessary in this case.

In one or more embodiments, an automatic annotation system may post-process the resulting bounding box to ensure that the bounding box is fully contained within the image. To do this, each of the points can be considered relative to the dimensions of the image itself. If any of the points are outside of the image edges, they can be truncated to the image edge.

In one or more embodiments, an automatic annotation system may perform additional post-processing if needed. For example, an automatic annotation system may determine a ratio of the bounding box size to the image size in order to normalize this by the size of the entire object in pixels. This may be achieved based on knowing the size of the object from the input data and the camera calibration. If this normalized ratio is below a threshold, it can be determined that only a small portion of the object is in the image and based on the hyperparameters selected can be rejected as a poor training image (too little robot in view). In machine learning, a hyperparameter is a parameter whose value is used to control the learning process. By contrast, the values of other parameters (typically node weights) are derived via training. Hyperparameters can be classified as model hyperparameters, that cannot be inferred while fitting the machine to the training set because they refer to the model selection task, or algorithm hyperparameters, that in principle have no influence on the performance of the model but affect the speed and quality of the learning process.

In one or more embodiments, an automatic annotation system may perform annotation set processing 608. The automatic annotation system may utilize the resulting bounding box data and other metadata needed from the image (e.g., filename, image dimensions, etc.) and output it in the appropriate annotation format. Annotation formats may include, but not limited to, Coco format or any other annotation format. Using the annotation format, an automatic annotation system may output appropriate data to a file. This process can be extended to multiple images or videos by applying the previous steps to each image in turn. A selection criteria can be incorporated to allocate the image to a testing or training set (e.g., every 30^{th} image to be used for training), or all image data can be used for same use case set (e.g., training) and a new database be used for the opposing use case set (e.g., testing). Output data may be stored during intermediate processing and compiled in full at the end using basic computing techniques (e.g., storing in appropriate variables or using object oriented programming to maintain correct sets). Output images may also be saved and stored to easily collate appropriate use case sets together

In one or more embodiments, utilizing the above bounding box techniques for each image, the frame can be further processed to get a fitted contour of the object, outlining the exact shape of the object edges.

In one or more embodiments, for each frame, an automatic annotation system may identify the foreground image frame via the bounding box identified above. The automatic annotation system may use a background subtraction algorithm to remove the background of the image.

In one or more embodiments, for each frame, an automatic annotation system may apply a thresholding mask to differentiate the remaining foreground from the rest of the image.

In one or more embodiments, for each frame, an automatic annotation system may dilate the existing pixel edges to fill in any gaps in the resulting binary image, then erode pixels to retrieve original foreground size. This technique relies on iterating through positive pixels and growing their edges if a gradient edge exists. Dilation is one of the two basic operators in the area of morphology, the other being erosion. It is typically applied to binary images, but there are versions that work on grayscale images. The basic effect of the operator on a binary image is to gradually enlarge the boundaries of regions of foreground pixels (e.g., white pixels, typically). Thus areas of foreground pixels grow in size while holes within those regions become smaller.

In one or more embodiments, for each frame, an automatic annotation system may run an edge detection algorithm (some example algorithms may include Sobel and Canny) and return the resulting edges as the contour points of the robot in pixels coordinates.

It is understood that the above descriptions are for purposes of illustration and are not meant to be limiting.

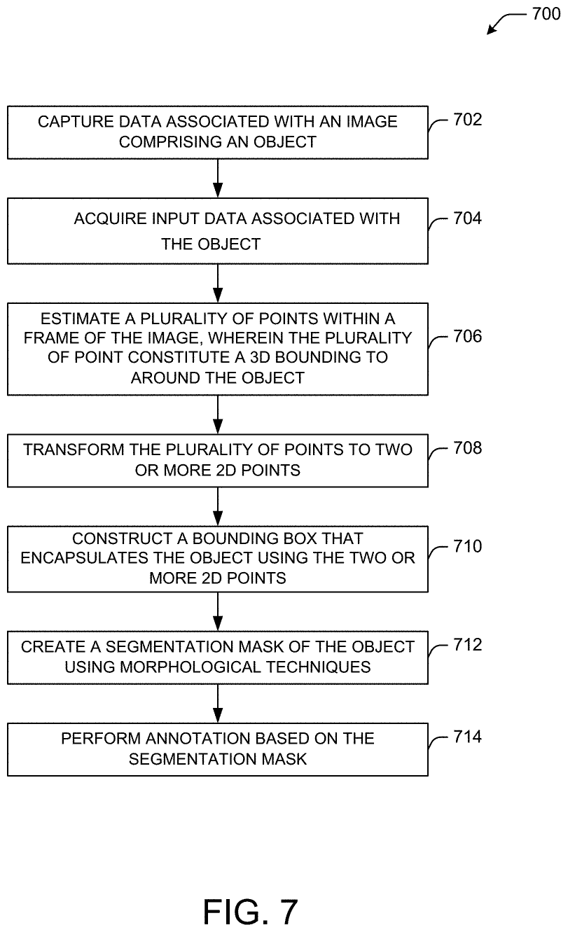

FIG. 7 illustrates a flow diagram of illustrative process 700 for an automatic annotation system, in accordance with one or more example embodiments of the present disclosure.

At block 702, a device may capture data associated with an image comprising an object.

At block 704, the device may acquire input data associated with the object.

At block 706, the device may estimate a plurality of points within a frame of the image, wherein the plurality of point constitute a 3D bounding to around the object.

At block 708, the device may transform the plurality of points to two or more 2D points.

At block 710, the device may construct a bounding box that encapsulates the object using the two or more 2D points.

At block 712, the device may create a segmentation mask of the object using morphological techniques.

At block 714, the device may perform annotation based on the segmentation mask.

It is understood that the above descriptions are for purposes of illustration and are not meant to be limiting.

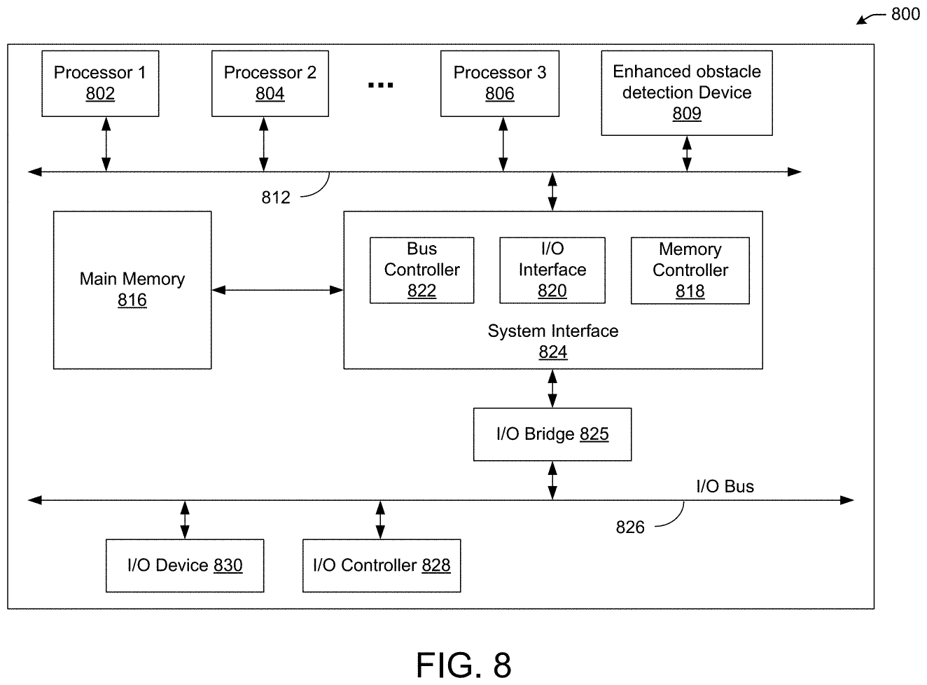

FIG. 8 is a block diagram illustrating an example of a computing device or computer system 800 upon which any of one or more techniques (e.g., methods) may be performed, in accordance with one or more example embodiments of the present disclosure.

For example, the computing system 800 of FIG. 8 may represent the automatic annotation system. The computer system (system) includes one or more processors 802-806. Processors 802-806 may include one or more internal levels of cache (not shown) and a bus controller (e.g., bus controller 822) or bus interface (e.g., I/O interface 820) unit to direct interaction with the processor bus 812. An automatic annotation device 809 may also be in communication with the Processors 802-806 and may be connected to the processor bus 812.

Processor bus 812, also known as the host bus or the front side bus, may be used to couple the processors 802-806 and/or the automatic annotation device 809 with the system interface 824. System interface 824 may be connected to the processor bus 812 to interface other components of the system 800 with the processor bus 812. For example, system interface 824 may include a memory controller 818 for interfacing a main memory 816 with the processor bus 812. The main memory 816 typically includes one or more memory cards and a control circuit (not shown). System interface 824 may also include an input/output (I/O) interface 820 to interface one or more I/O bridges 825 or I/O devices 830 with the processor bus 812. One or more I/O controllers and/or I/O devices may be connected with the I/O bus 826, such as I/O controller 828 and I/O device 830, as illustrated.

I/O device 830 may also include an input device (not shown), such as an alphanumeric input device, including alphanumeric and other keys for communicating information and/or command selections to the processors 802-806 and/or the automatic annotation device 809. Another type of user input device includes cursor control, such as a mouse, a trackball, or cursor direction keys for communicating direction information and command selections to the processors 802-806 and/or the automatic annotation device 809 and for controlling cursor movement on the display device.

System 800 may include a dynamic storage device, referred to as main memory 816, or a random access memory (RAM) or other computer-readable devices coupled to the processor bus 812 for storing information and instructions to be executed by the processors 802-806 and/or the automatic annotation device 809. Main memory 816 also may be used for storing temporary variables or other intermediate information during execution of instructions by the processors 802-806 and/or the automatic annotation device 809. System 800 may include read-only memory (ROM) and/or other static storage device coupled to the processor bus 812 for storing static information and instructions for the processors 802-806 and/or the automatic annotation device 809. The system outlined in FIG. 8 is but one possible example of a computer system that may employ or be configured in accordance with aspects of the present disclosure.

According to one embodiment, the above techniques may be performed by computer system 800 in response to processor 804 executing one or more sequences of one or more instructions contained in main memory 816. These instructions may be read into main memory 816 from another machine-readable medium, such as a storage device. Execution of the sequences of instructions contained in main memory 816 may cause processors 802-806 and/or the automatic annotation device 809 to perform the process steps described herein. In alternative embodiments, circuitry may be used in place of or in combination with the software instructions. Thus, embodiments of the present disclosure may include both hardware and software components.

According to one embodiment, the processors 802-806 may represent machine learning models. For example, the processors 802-806 may allow for neural networking and/or other machine learning techniques used in this disclosure. For example, the processors 802-806 may include tensor processing units (TPUs) having artificial intelligence application-specific integrated circuits (ASICs), and may facilitate computer vision and other machine learning techniques for image analysis and generation.

In one or more embodiments, the computer system 800 may perform any of the steps of the processes described with respect to FIG. 7.

Various embodiments may be implemented fully or partially in software and/or firmware. This software and/or firmware may take the form of instructions contained in or on a non-transitory computer-readable storage medium. Those instructions may then be read and executed by one or more processors to enable the performance of the operations described herein. The instructions may be in any suitable form, such as, but not limited to, source code, compiled code, interpreted code, executable code, static code, dynamic code, and the like. Such a computer-readable medium may include any tangible non-transitory medium for storing information in a form readable by one or more computers, such as but not limited to read-only memory (ROM); random access memory (RAM); magnetic disk storage media; optical storage media; a flash memory, etc.

A machine-readable medium includes any mechanism for storing or transmitting information in a form (e.g., software, processing application) readable by a machine (e.g., a computer). Such media may take the form of, but is not limited to, non-volatile media and volatile media and may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, solid state devices (SSDs), and the like. The one or more memory devices (not shown) may include volatile memory (e.g., dynamic random access memory (DRAM), static random access memory (SRAM), etc.) and/or non-volatile memory (e.g., read-only memory (ROM), flash memory, etc.).

Computer program products containing mechanisms to effectuate the systems and methods in accordance with the presently described technology may reside in main memory 816, which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

Embodiments of the present disclosure include various steps, which are described in this specification. The steps may be performed by hardware components or may be embodied in machine-executable instructions, which may be used to cause a general-purpose or special-purpose processor programmed with the instructions to perform the steps. Alternatively, the steps may be performed by a combination of hardware, software, and/or firmware.

Various modifications and additions can be made to the exemplary embodiments discussed without departing from the scope of the present disclosure. For example, while the embodiments described above refer to particular features, the scope of this disclosure also includes embodiments having different combinations of features and embodiments that do not include all of the described features. Accordingly, the scope of the present disclosure is intended to embrace all such alternatives, modifications, and variations together with all equivalents thereof.

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

The word “exemplary” is used herein to mean “serving as an example, instance, or illustration.” Any embodiment described herein as “exemplary” is not necessarily to be construed as preferred or advantageous over other embodiments.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or any other manner.

It is understood that the above descriptions are for purposes of illustration and are not meant to be limiting.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure.

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

What is claimed is:

1. A method comprising:
capturing data associated with an image comprising an object;
acquiring input data associated with the object;
estimating a plurality of points within a frame of the image, wherein the plurality of point constitute a 3D bounding to around the object;
transforming the plurality of points to two or more 2D points;
constructing a bounding box that encapsulates the object using the two or more 2D points;
creating a segmentation mask of the object using morphological techniques; and
performing annotation based on the segmentation mask.

2. The method of claim 1, wherein the input data comprise object dimensions data, camera calibration data, or time synchronized ground truth data.

3. The method of claim 1, wherein estimating the plurality of points comprises calculating 3D coordinates of each of the plurality of points.

4. The method of claim 1, wherein transforming the plurality of points to two or more 2D points comprises converting the 3D coordinates of each of the plurality of points to 2D coordinates in a plane of the image.

5. The method of claim 1, wherein creating a segmentation mask of the object comprises at least one of background subtraction, morphological analysis, and bounding box limitations.

6. The method of claim 1, further comprising performing object position validation and inclusion checks.

7. The method of claim 1, wherein the plurality of points equals eight 3D bounding cube points in a world frame.

8. The method of claim 7, wherein transforming the plurality of points to two or more 2D points comprises downsampling eight 3D bounding cube points to four points defining a 2D bounding box.

9. The method of claim 8, wherein the downsampling the eight 3D bounding cube points to four points defining a 2D bounding box comprises selecting the minimum and maximum values associated with a two point row and column format of the eight 3D bounding cube points.

10. A device, the device comprising processing circuitry coupled to storage, the processing circuitry configured to:
capture data associated with an image comprising an object;
acquire input data associated with the object;
estimate a plurality of points within a frame of the image, wherein the plurality of point constitute a 3D bounding to around the object;
transform the plurality of points to two or more 2D points;
construct a bounding box that encapsulates the object using the two or more 2D points;
create a segmentation mask of the object using morphological techniques; and
perform annotation based on the segmentation mask.

11. The device of claim 10, wherein the input data comprise object dimensions data, camera calibration data, or time synchronized ground truth data.

12. The device of claim 10, wherein estimating the plurality of points comprises calculating 3D coordinates of each of the plurality of points.

13. The device of claim 10, wherein transforming the plurality of points to two or more 2D points comprises converting the 3D coordinates of each of the plurality of points to 2D coordinates in a plane of the image.

14. The device of claim 10, wherein creating a segmentation mask of the object comprises at least one of background subtraction, morphological analysis, and bounding box limitations.

15. The device of claim 10, wherein the processing circuitry is further configured to perform object position validation and inclusion checks.

16. The device of claim 10, wherein the plurality of points equals eight 3D bounding cube points in a world frame.

17. The device of claim 16, wherein transforming the plurality of points to two or more 2D points comprises downsampling eight 3D bounding cube points to four points defining a 2D bounding box.

18. The device of claim 17, wherein the downsampling the eight 3D bounding cube points to four points defining a 2D bounding box comprises selecting the minimum and maximum values associated with a two point row and column format of the eight 3D bounding cube points.

19. A non-transitory computer-readable medium storing computer-executable instructions which when executed by one or more processors result in performing operations comprising:
capturing data associated with an image comprising an object;
acquiring input data associated with the object;
estimating a plurality of points within a frame of the image, wherein the plurality of point constitute a 3D bounding to around the object;
transforming the plurality of points to two or more 2D points;
constructing a bounding box that encapsulates the object using the two or more 2D points;
creating a segmentation mask of the object using morphological techniques; and
performing annotation based on the segmentation mask.

20. The non-transitory computer-readable medium of claim 19, wherein the input data comprise object dimensions data, camera calibration data, or time synchronized ground truth data.
